(19) United States
(12) Patent Application Publication
(10) Pub. No.: US 2026/0008073 A1
(43) Pub. Date: Jan. 8, 2026

(54) VENTILATION FLUID SUPPLY CUP

(71) Applicant: QINGDAO HANBO PLASTIC TECHNOLOGY CO., LTD., Qingdao (CN)

(72) Inventor: Yun XIAO, Qingdao (CN)

(73) Assignee: QINGDAO HANBO PLASTIC TECHNOLOGY CO., LTD., Qingdao (CN)

(21) Appl. No.: 19/329,855

(22) Filed: Sep. 16, 2025

Related U.S. Application Data
(63) Continuation of application No. PCT/CN2023/120666, filed on Sep. 22, 2023.

(30) Foreign Application Priority Data
Mar. 23, 2023 (CN) 202310293601.5

(51) Int. Cl. B05B 11/00

(52) U.S. Cl. CPC B05B 11/0039

(57) ABSTRACT

A ventilation fluid supply cup has a container arranged with a vent hole, the vent hole is closed by a valve, the valve includes a valve housing arranged at a corresponding position of the container, the valve housing is arranged with a closing element, the valve housing includes at least one hollow column protruding around a periphery of the vent hole, the hollow column is arranged with at least one vent opening, the closing element is arranged with a vent position matched with the vent opening, the closing element is capable of rotating along a circumferential direction of the valve housing; the vent opening and the vent position are connected to make pressure between an inside of the container and an external environment balanced; the vent opening and the vent position are in a disconnected state to close the vent opening by a side wall of the closing element.

### TECHNICAL FIELD

The present disclosure relates to the technical field of fluid supply of paint spray guns, in particularly to a ventilation fluid supply cup.

### BACKGROUND

Liquid supply devices generally refers to paint spray cups, which are used to store paint. When in use, the paint spray cup is connected to a paint spray gun to spray the paint inside the paint spray cup. There are two main types of paint spray cups on the market: one is composed of a cup body and a cup cover, and the other is composed of a rigid outer cup, an inner lining, a cup cover, and a thread fixing ring.

The Chinese invention patent with the patent number of 201380039900.0 and the title of Gas-Discharge Assembly and Reservoir Including the Gas-discharge Assembly discloses a rotary ventilation method, where multiple vent holes are arranged at a base, and the vent holes are closed or opened by cooperating with through holes at the gas-discharge assembly. When the gas-discharge assembly is rotated to open, the holes at the gas-discharge assembly overlap with the vent holes, which causes paint in a fluid supply cup to splash out from the overlapping holes. Although the balance of air pressure inside and outside the fluid supply cup is achieved, the paint splashed during the opening process pollutes environments.

The Chinese invention patent with the patent number of 202111041366.X and the title of Fluid Supply Cup for Paint Spray Gun discloses a lift-type ventilation method, where a block part causes paint in a fluid supply cup to splash out from overlapping holes at the moment of opening.

Therefore, the prior art needs to be further improved and developed.

### SUMMARY

In view of the above-mentioned defects of the prior art, the present disclosure aims to provide a ventilation fluid supply cup, which can reduce paint splashing while ensuring ventilation of the fluid supply cup.

To solve the above-mentioned problems, technical solutions of the present disclosure are as follows.

A ventilation fluid supply cup is provided, where the ventilation fluid supply cup has a container, the container is arranged with a vent hole, the vent hole is closed by a valve, the valve includes a valve housing arranged at a corresponding position of the container, the valve housing is arranged with a closing element, the valve housing includes at least one hollow column protruding around a periphery of the vent hole, the hollow column is arranged with at least one vent opening, the closing element is arranged with a vent position matched with the vent opening, the closing element is capable of rotating along a circumferential direction of the valve housing; the vent opening and the vent position are in a connected state to make pressure between an inside of the container and an external environment balanced; the vent opening and the vent position are in a disconnected state to close the vent opening by a side wall of the closing element; the closing element is arranged at the valve housing by a limiting mechanism or a locking mechanism.

In the ventilation fluid supply cup, the vent opening is arranged at a side wall of the hollow column, or a plurality of vent openings are arranged at the side wall of the hollow column to form a vent area.

In the ventilation fluid supply cup, two vent openings are symmetrically arranged at the side wall of the hollow column.

In the ventilation fluid supply cup, the vent opening is a U-type opening.

In the ventilation fluid supply cup, the valve housing further includes a valve seat, the valve seat surrounds a periphery of the hollow column, an air-permeable structure is arranged at a side wall of the valve seat, and the closing element is combined with the valve seat by the limiting mechanism or the locking mechanism.

In the ventilation fluid supply cup, the air-permeable structure is a through hole, a notch or a gap, or a strip-shaped passage, the strip-shaped passage is arranged along a height direction of the side wall of the valve seat, and a concave surface of the strip-shaped passage is lower than a surface of the side wall of the valve seat.

In the ventilation fluid supply cup, the closing element includes a hollow column-shaped base, a hollow column-shaped member is arranged at the column-shaped base, the hollow column-shaped member is matched with the hollow column, and the vent position is arranged at a side wall of the hollow column-shaped member.

In the ventilation fluid supply cup, the hollow column-shaped member is inserted into the hollow column, and the vent opening is closed by an outer surface of the side wall of the hollow column-shaped member.

In the ventilation fluid supply cup, the hollow column-shaped member is sleeved at the hollow column, and the vent opening is closed by an inner surface of the side wall of the hollow column-shaped member.

In the ventilation fluid supply cup, the column-shaped base is inserted into the valve seat, or the column-shaped base is sleeved at the valve seat.

In the ventilation fluid supply cup, the limiting mechanism or the locking mechanism includes an annular groove arranged at the side wall of the valve seat, and an annular hoop arranged at the closing element; or the limiting mechanism or the locking mechanism includes an annular hoop arranged at the side wall of the valve seat, and an annular groove arranged at the closing element;
where the annular groove is matched with the annular hoop to make the closing element capable of rotating along the circumferential direction of the valve housing.

In the ventilation fluid supply cup, a first limiting structure is arranged at the side wall of the valve seat, and a second limiting structure is arranged at the closing element, and the first limiting structure cooperates with the second limiting structure to control the connected state or the disconnected state between the vent opening and the vent position.

In the ventilation fluid supply cup, the first limiting structure is two stoppers, the two stoppers are symmetrically arranged at the side wall of the valve seat; the second limiting structure is two stop sheets or two stop blocks, the two stop sheets or the two stop blocks are arranged at the column-shaped base or the hollow column-shaped member of the closing element.

In the ventilation fluid supply cup provided by the present disclosure, the method of arranging the vent opening on the side wall of the hollow column is adopted. The vent opening is opened by the rotation of the closing element to balance the pressure between the inside and outside of the fluid supply cup. In the process of opening, gas is not directly sprayed upward along the vent hole, but is ventilated through the vent opening on the side wall, thereby avoiding the gas from splashing linearly from the bottom of the container. The linear splashed part is intercepted by a blocking part of the closing element, which greatly reduces the paint splashing effect when the ventilation is opened. Of course, in order to further reduce the paint splashing phenomenon, a column-shaped valve seat can be arranged on the periphery of the hollow column to seal the paint splashed from the side surface between the hollow column and the valve seat, completely eliminating the paint splashing during ventilation.

### BRIEF DESCRIPTION OF DRAWINGS

FIG. 1 is a schematic structural diagram of a fluid supply cup in the present disclosure.

FIG. 2 is a schematic diagram of an embodiment of a valve housing in the present disclosure.

FIG. 3 is a schematic diagram of another embodiment of the valve housing in the present disclosure.

FIG. 4 is a schematic diagram of a third embodiment of the valve housing in the present disclosure.

FIG. 5 is a schematic diagram of a fourth embodiment of the valve housing in the present disclosure.

FIG. 6 is a schematic diagram of the combination of a closing element and the valve housing in the present disclosure.

FIG. 7 is a schematic diagram of an embodiment of the closing element in the present disclosure.

FIG. 8 is a schematic diagram of another embodiment of the closing element in the present disclosure.

FIG. 9 is a schematic diagram showing a connected state in the present disclosure, where a hollow column-shaped member is inserted into a hollow column and a column-shaped base is inserted into a valve seat.

FIG. 10 is a schematic diagram showing a disconnected state in the present disclosure, where the hollow column-shaped member is inserted into the hollow column and the column-shaped base is inserted into the valve seat.

FIG. 11 is a schematic diagram showing a connected state in the present disclosure, where the hollow column-shaped member is sleeved on the hollow column and the column-shaped base is inserted into the valve seat.

FIG. 12 is a schematic diagram showing a disconnected state in the present disclosure, where the hollow column-shaped component is sleeved at the hollow column and the column-shaped base is inserted into the valve seat.

### DETAILED DESCRIPTION OF EMBODIMENTS

The present disclosure provides a ventilation fluid supply cup. To make the purposes, technical solutions, and effects of the present disclosure clearer and more specific, the present disclosure is further described in detail below. It should be understood that the embodiments described herein are only used to explain the present disclosure and are not used to limit the present disclosure.

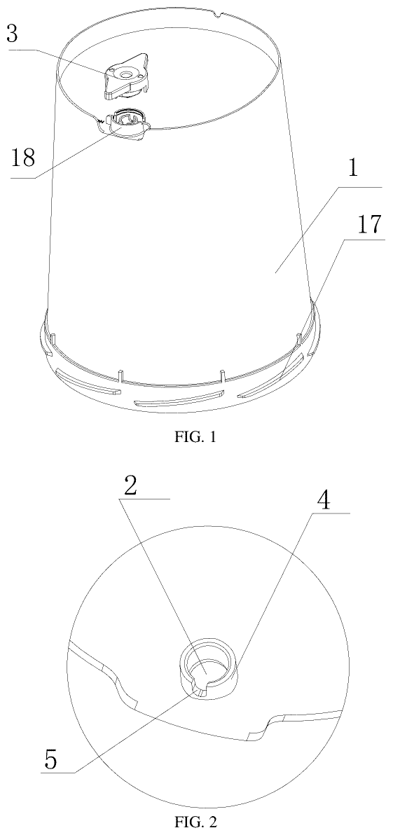

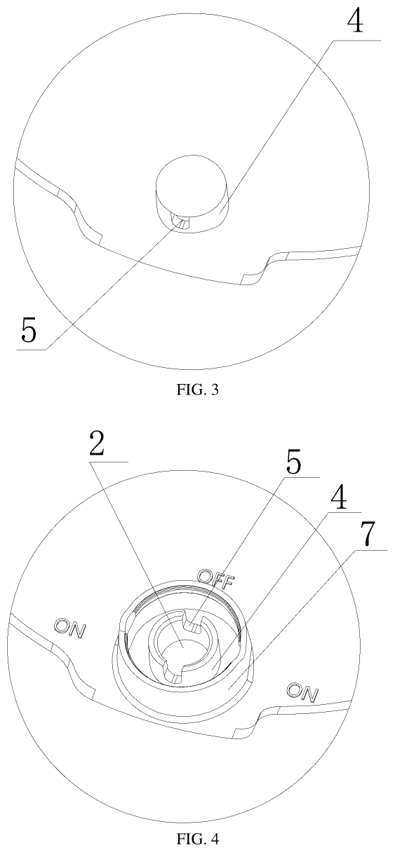

The present disclosure provides a ventilation fluid supply cup, as shown in FIG. 1, FIG. 2, FIG. 3, and FIG. 4. The ventilation fluid supply cup has a container 1, the container includes a bucket-shaped container and a cover that can be screwed onto the container through a thread 17. Of course, there are many ways to connect the cover and the container 1. A top side of the cover is arranged with an outlet connector having an outlet, and a connector is formed outside the outlet connector. The connector is configured to sleeve and fix a fluid reservoir on a paint spray gun or on an adapter arranged between the paint spray gun and the fluid reservoir. There are many forms of methods for constructing the cover and the container, which are not repeated here.

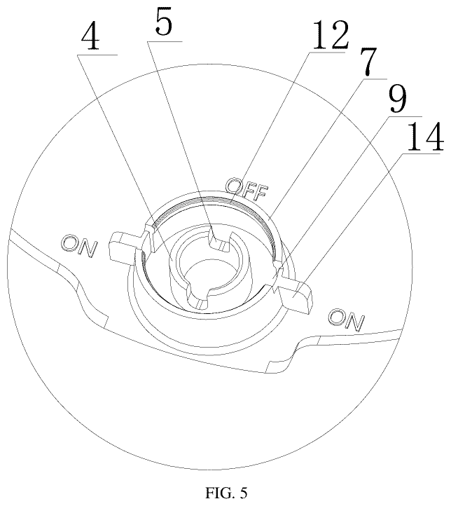

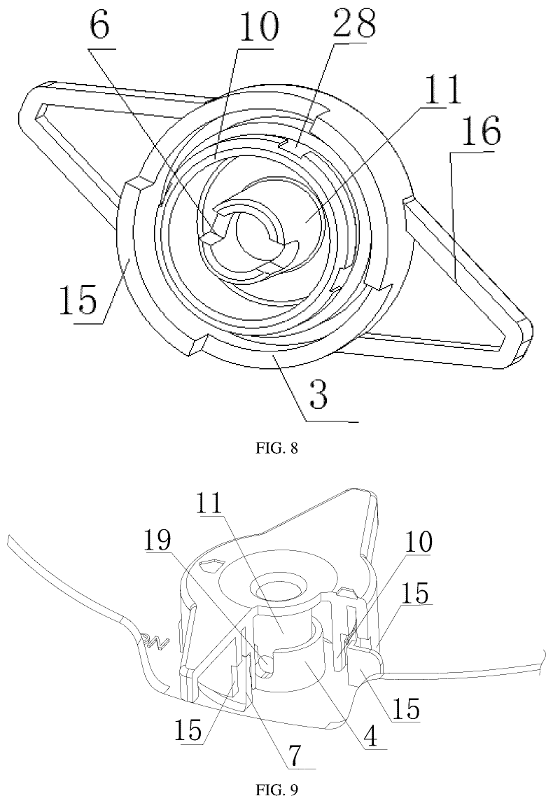

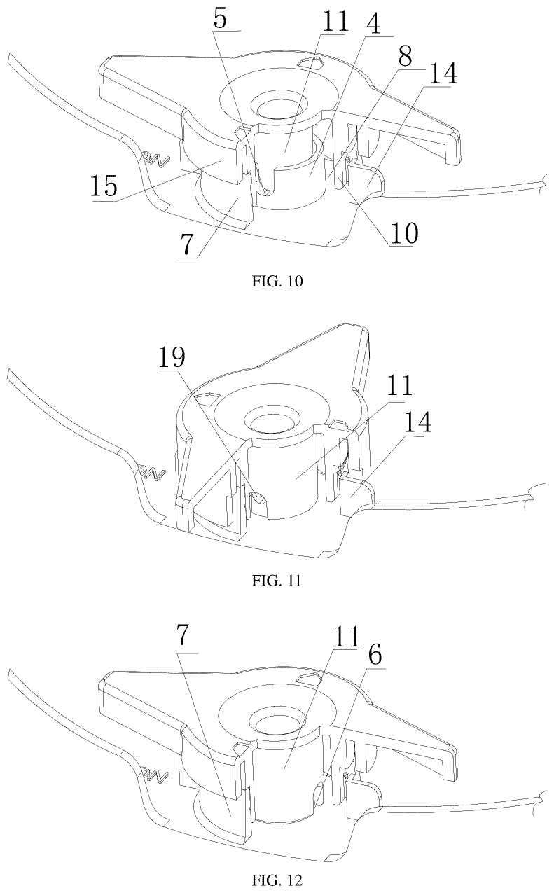

The container 1 is provided with a vent hole 2 which is closed by means of a valve. The vent hole 2 is generally arranged at a bottom of the container. The valve includes a valve housing 18 which is arranged at a corresponding position of the container 1. As shown in FIG. 7 and FIG. 8, the valve housing is provided with a closing element 3, and the valve housing 18 includes at least one hollow column 4 which protrudes around a periphery of the vent hole 2. There are many types of valve housings. As shown in FIG. 2, FIG. 3, FIG. 4, and FIG. 5, the hollow column 4 can be opened at its upper end or closed at its upper end. The closing element 3 can be inserted into the hollow column 4 or sleeved on the hollow column 4. At least one vent opening 5 is arranged on the hollow column 4. Generally, the vent opening 5 is arranged on a side wall of the hollow column 4. As shown in FIG. 7 and FIG. 8, the closing element 3 is provided with a vent position 6 which is matched with the vent opening 5. The vent position 6 has the same structure as the vent opening 5. The vent position 6 may be a vent area composed of a plurality of through holes, or a gauze can be arranged on the vent position 6, which is not described in detail here. The closing element 3 can rotate along a circumferential direction of the valve housing to make the vent opening 5 and the vent position 6 in a connected state, so that pressure between inside and outside of the container 1 is balanced, that is, when the container is opened, the amount of paint splashing is greatly reduced. The vent opening 5 and the vent position 6 are in a disconnected state, that is, the vent opening 5 and the vent position 6 are in a completely misaligned state, and there is no intersection between the two air-permeable areas. The vent opening 5 is closed by a side wall of the closing element 3, where the vent opening 5 is generally closed by an interference fit. Of course, the vent opening 5 may be closed by providing a protrusion at a corresponding position of the side wall of the closing element 3. The closing element 3 is arranged at the valve housing 18 by a limiting mechanism or a locking mechanism, and its arrangement methods are shown in FIG. 9, FIG. 10, FIG. 11, and FIG. 12. In order to achieve the above functions, structures of the closing element can be appropriately deformed and combined.

Further, as shown in FIG. 2 and FIG. 3, the above-mentioned vent opening 5 is arranged on the side wall of the hollow column 4. Of course, a plurality of vent openings 5 can be arranged on the side wall of the hollow column to form a vent area, which is not shown in the figures. An aperture of the vent opening 5 can be controlled, so that the amount of paint splashing can be further controlled.

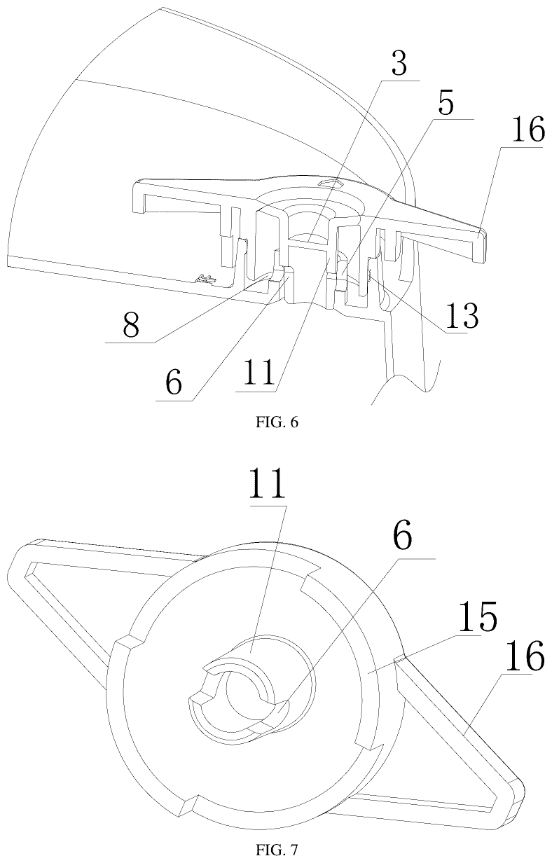

In some embodiments, two vent openings 5 are provided and arranged on the side wall of the hollow column 4 in a symmetrical manner, generally with an axis of the hollow column as a symmetry line, so that the two vent openings 5 can be opened at the same time, thereby improving air permeability. In addition, the hollow column 4 is opened at its upper end, and the vent opening 5 is a U-type opening. Similarly, the vent position 6 can be set as the same U-type opening on the closing element 3, as shown in FIG. 6, and the two cooperate to form a through-hole shape 19 when they are in the connected state.

In some embodiments, as shown in FIG. 4 and FIG. 5, the valve housing 18 further includes a valve seat 7, which surrounds a periphery of the hollow column 4. For example, the valve seat 7 and the hollow column 4 may be concentric cylinders, and a diameter of the valve seat 7 is greater than a diameter of the hollow column 4. Alternatively, the valve seat 7, the hollow column 4, and the vent hole 2 may be concentric, as shown in FIG. 5, FIG. 9, and FIG. 10, that is, an accommodation space 8 is formed between an inner wall of the valve seat 7 and an outer wall of the hollow column 4. In addition, an air-permeable structure is provided on a side wall of the valve seat 7. When the two vent openings 5 are connected to the corresponding vent position 6, the paint splashing therefrom is blocked by the valve seat 7 and enclosed in the accommodation space 8, thereby avoiding the problem of paint splashing during the valve-opening process. The above-mentioned closing element 3 is combined with the valve seat 7 through a limiting mechanism or a locking mechanism, so that circumferential rotation of the closing element 3 is smoother.

Further, as shown in FIG. 5, the above-mentioned air-permeable structure is a through hole, a notch, or a gap. The notch 9 adopted in the present embodiment is intended to reduce the contact space between the above-mentioned accommodation space 8 and an external environment and ensure a smooth operation of airflow. The accommodation space 8 can be always connected to the external environment through an assembly space between the closing element 3 and the valve housing.

Of course, a strip-shaped passage can also be set along a height direction of the side wall of the valve seat 7. The strip-shaped passage is located on an outer surface of the valve seat 7, and a concave surface of the strip-shaped passage is lower than a surface of the side wall of the valve seat 7. That is to say, the strip-shaped passage and an inner wall of a corresponding position of the closing element 3 form an airflow passage to ensure the connection between the external environment and the accommodation space 8.

In some embodiments, as shown in FIG. 8, the above-mentioned closing element 3 includes a hollow column-shaped base 10, and a hollow column-shaped member 11 is arranged on the hollow column-shaped base 10. The hollow column-shaped member 11 is adapted to the hollow column 4, and the above-mentioned vent position 6 is arranged on a side wall of the hollow column-shaped member 11. As shown in FIG. 9 and FIG. 10, the above-mentioned hollow column-shaped member 11 is inserted into the hollow column 4, the vent opening 5 is closed by an outer surface of the side wall of the hollow column-shaped member 11, and the vent positions 6 are symmetrically arranged on the hollow column-shaped member 11 in the form of two U-type openings. Generally, the outer surface of the side wall of the hollow column-shaped member 11 has a taper, and an inner surface of the hollow column 4 further has a taper. An interference connection is achieved by the matching of the tapers of the two surfaces, thereby ensuring the stability of closing or opening the vent opening 5. Of course, the setting of the taper can be determined according to the an assembly method of the hollow column-shaped member 11 and the hollow column 4.

When the closing element 3 is rotated to make the vent opening 5 overlapped with the vent position 6, the balance of the fluid supply cup and the external air pressure is achieved. The process of gradually opening the vent opening 5 and the vent position 6 is an opening process from a narrow gap to a through hole, which minimizes the degree of paint splashing.

As shown in FIG. 11 and FIG. 12, the hollow column-shaped member 11 can be sleeved on the hollow column 4, and the vent opening 5 can be closed by the inner surface of the side wall of the hollow column-shaped member 11. The operation principle and process are the same as those described above and are not be described in detail here.

Further, as shown in FIG. 9 and FIG. 10, the column-shaped base 10 is inserted into the valve seat 7, and a circulated gas path can be achieved through the assembly space between the column-shaped base 10 and the valve seat 7. Of course, a plurality of strip-shaped passages 28 can also be arranged on an outer surface of a side wall of the column-shaped base 10, and a lower edge of the side wall of the column-shaped base 10 does not contact the bottom of the container 1, so that the outer surface of the side wall of the column-shaped base 10 and an inner surface of the valve seat 7 cooperate with each other to form a connection between the external environment and the accommodation space 8.

Of course, the column-shaped base 10 can be sleeved on the valve seat 7, and the strip-shaped passage 28 is arranged on an inner surface of the side wall of the column-shaped base 10, so that the inner surface of the side wall of the column-shaped base 10 and the outer surface of the valve seat 7 cooperate with each other, and the lower edge of the side wall of the column-shaped base 10 does not contact the bottom of the container 1, thereby forming a connection between the external environment and the accommodation space 8.

In some embodiments, as shown in FIG. 5, FIG. 6, FIG. 9, and FIG. 10, the above-mentioned limiting mechanism or locking mechanism includes an annular groove 12 arranged on the side wall of the valve seat 7, and an annular hoop 13 arranged on the closing element 3. The annular groove 12 is arranged on the inner surface of the side wall of the valve seat 7, and the annular hoop 13 is arranged on an outer surface of the column-shaped base 10. The annular groove 12 and the annular hoop 13 are matched. After installation, the closing element 3 can only rotate along the circumferential direction of the valve housing, and cannot move up and down at the valve seat 7. Arrangement positions of the annular groove 12 and the annular hoop 13 can be interchanged, for example, the annular hoop 13 is arranged on the side wall of the valve seat 7, and the annular groove 12 is arranged on the closing element 3. A main purpose thereof is to make the annular groove 12 and the annular hoop 13 matched so that the closing element 3 can rotate along the circumferential direction of the valve housing.

Of course, it can only arrange the annular hoop 13 on the side wall of the valve seat 7, and the annular hoop 13 and the side wall of the column-shaped base 10 form an interference fit to achieve the purpose of limiting or locking. Of course, the annular hoop 13 can also be arranged on the side wall of the column-shaped base 10, and the annular hoop 13 and the side wall of the valve seat 7 form an interference fit to achieve the purpose of limiting or locking. Of course, other forms of limiting mechanisms or locking mechanisms can also be used, which are not listed here one by one.

In some embodiments, as shown in FIG. 5, FIG. 9, FIG. 10, FIG. 11, and FIG. 12, a first limiting structure is arranged on the side wall of the valve seat 7, and a second limiting structure is arranged on the closing element 3. The first limiting structure cooperates with the second limiting structure to control the connected state or the disconnected state between the vent opening and the vent position. The first limiting structure is two stoppers 14, which are arranged on the side wall of the valve seat 7 in a symmetrical manner. In the present embodiment, the two stoppers 14 are arranged opposite to the notch 9. Of course, in order to control a rotation angle of the closing element 3, or to form a mark to facilitate users' use habits, the arrangement positions of the stoppers 14 can be adjusted to meet users' needs. The second limiting structure is two stop sheets or two stop blocks. In the present embodiment, the stop sheets 15 are adopted, and the two stop blocks or stop sheets are arranged on the column-shaped base or hollow column-shaped member of the closing element 3. The arrangement positions of the stop sheets 15 need to be related to the matching method of the column-shaped base 10 and the valve seat 7. The stop sheets 15 in the present embodiment are an arc-shaped stop sheet. For example, the column-shaped base 10 is inserted into the valve seat 7, the stoppers 14 are arranged on the outer surface of the side wall of the valve seat 7, and the stop sheets 15 are arranged on a side edge of a top part of the column-shaped base 10 and extends along a curvature of the outer surface of the side wall of the valve seat 7, so that the stop sheets also has a function of guide rail to allow the closing element 3 to rotate more smoothly. When a corresponding end of the stop sheet 15 contacts a corresponding surface of the corresponding stopper 14, the vent opening 5 is overlapped with the vent position 6. When the other corresponding end of the stop sheet 15 contacts a corresponding surface of the other corresponding stopper 14, the vent opening 5 is completely separated from the vent position 6, and the vent opening 5 is closed by the side wall of the hollow column-shaped member 11, thereby realizing the closing and opening of the vent opening 5. Further, by cooperating with the stop sheets 15 and the stoppers 14, the closing element 3 can be limited to rotate between 0°-90° to realize the opening or closing of the vent opening 5. As shown in FIG. 7, FIG. 8, FIG. 9, and FIG. 10, a rotation handle 16 is arranged on the closing element 3 to facilitate user operation, and users can also determine whether the vent opening 5 is in an opened or closed state according to the position of the rotation handle 16. Of course, the opened or closed state of the vent opening 5 can be clearly marked directly on the bottom of the container 1.

Further, a protrusion with an interference function can be provided between the two stop sheets 15. For example, the protrusion is arranged on the column-shaped base 10, and one protrusion can be provided close to a corresponding end of the stop sheet 15, and a total of four protrusions are arranged on the closing element 3. There is a contact position between the protrusion and the corresponding end of the stop sheet 15, and the contact position is adapted to the width of the above-mentioned stopper 14. For example, when the vent opening 5 is in the closed state, the stopper 14 is located by the protrusion to prevent paint from leaking from the bottom of the container 1 caused by the closing element 3 rotating randomly. Similarly, when the vent opening 5 is in the opened state, it is also ensured that the closing element 3 is not closed randomly. Of course, the protrusion can also be arranged on the side wall of the valve seat 7, and its setting position can be determined according to the assembly method of the valve seat 7 and the closing element 3. Of course, other settings can be made according to actual needs, which are not repeated here.

Of course, the above description is not a limitation of the present disclosure, and the present disclosure is not limited to the above examples. Changes, modifications, additions, or substitutions made by those skilled in the art within the essential scope of the present disclosure should fall within the protection scope of the present disclosure.

What is claimed is:

1. A ventilation fluid supply cup, comprising:
a container, the container is arranged with a vent hole, the vent hole is closed by a valve, the valve comprises a valve housing arranged at a corresponding position of the container, the valve housing is arranged with a closing element, the valve housing comprises at least one hollow column protruding around a periphery of the vent hole, the hollow column is arranged with at least one vent opening, the closing element is arranged with a vent position matched with the vent opening, the closing element is capable of rotating along a circumferential direction of the valve housing; the vent opening and the vent position are in a connected state to make pressure between an inside of the container and an external environment balanced; the vent opening and the vent position are in a disconnected state to close the vent opening by a side wall of the closing element; and the closing element is arranged at the valve housing by a limiting mechanism or a locking mechanism.

2. The ventilation fluid supply cup according to claim 1, wherein the vent opening is arranged at a side wall of the hollow column, or a plurality of vent openings are arranged at the side wall of the hollow column to form a vent area.

3. The ventilation fluid supply cup according to claim 1, wherein two vent openings are symmetrically arranged at a side wall of the hollow column.

4. The ventilation fluid supply cup according to claim 1, wherein the vent opening is a U-type opening.

5. The ventilation fluid supply cup according to claim 1, wherein the valve housing further comprises a valve seat, the valve seat surrounds a periphery of the hollow column, an air-permeable structure is arranged at a side wall of the valve seat, and the closing element is combined with the valve seat by the limiting mechanism or the locking mechanism.

6. The ventilation fluid supply cup according to claim 5, wherein the air-permeable structure is a through hole, a notch or a gap, or a strip-shaped passage, the strip-shaped passage is arranged along a height direction of the side wall of the valve seat, and a concave surface of the strip-shaped passage is lower than a surface of the side wall of the valve seat.

7. The ventilation fluid supply cup according to claim 5, wherein the closing element comprises a hollow column-shaped base, a hollow column-shaped member is arranged at the column-shaped base, the hollow column-shaped member is matched with the hollow column, and the vent position is arranged at a side wall of the hollow column-shaped member.

8. The ventilation fluid supply cup according to claim 7, wherein the hollow column-shaped member is inserted into the hollow column, and the vent opening is closed by an outer surface of the side wall of the hollow column-shaped member.

9. The ventilation fluid supply cup according to claim 7, wherein the hollow column-shaped member is sleeved at the hollow column, and the vent opening is closed by an inner surface of the side wall of the hollow column-shaped member.

10. The ventilation fluid supply cup according to claim 7, wherein the column-shaped base is inserted into the valve seat, or the column-shaped base is sleeved at the valve seat.

11. The ventilation fluid supply cup according to claim 5, wherein the limiting mechanism or the locking mechanism comprises an annular groove arranged at the side wall of the valve seat, and an annular hoop arranged at the closing element; or the limiting mechanism or the locking mechanism comprises an annular hoop arranged at the side wall of the valve seat, and an annular groove arranged at the closing element; wherein the annular groove is matched with the annular hoop to make the closing element capable of rotating along the circumferential direction of the valve housing.

12. The ventilation fluid supply cup according to claim 7, wherein a first limiting structure is arranged at the side wall of the valve seat, and a second limiting structure is arranged at the closing element, and the first limiting structure cooperates with the second limiting structure to control the connected state or the disconnected state both between the vent opening and the vent position.

13. The ventilation fluid supply cup according to claim 12, wherein the first limiting structure is two stoppers, the two stoppers are symmetrically arranged at the side wall of the valve seat; the second limiting structure is two stop sheets or two stop blocks, the two stop sheets or the two stop blocks are arranged at the column-shaped base or the hollow column-shaped member of the closing element.
